(19) United States
(12) Patent Application Publication
(10) Pub. No.: US 2014/0192178 A1
(43) Pub. Date: Jul. 10, 2014

(54) METHOD AND SYSTEM FOR TRACKING MOTION OF MICROSCOPIC OBJECTS WITHIN A THREE-DIMENSIONAL VOLUME

(71) Applicants: Chao-Hui Huang, Singapore (SG); Shvetha Sankaran, Singapore (SG); Sohail Ahmed, Singapore (SG); Daniel Racoceanu, Beijing (SG); Srivats Hariharan, Singapore (SG)

(72) Inventors: Chao-Hui Huang, Singapore (SG); Shvetha Sankaran, Singapore (SG); Sohail Ahmed, Singapore (SG); Daniel Racoceanu, Beijing (SG); Srivats Hariharan, Singapore (SG)

(73) Assignee: Agency for Science, Technology and Research, Singapore (SG)

(21) Appl. No.: 14/238,727

(22) PCT Filed: Aug. 13, 2012
(86) PCT No.: PCT/SG2012/000287

§ 371 Date: Feb. 12, 2014

(30) Foreign Application Priority Data
Aug. 12, 2011 (SG) 201105862-5

(51) Int. Cl. G02B 21/36

(52) U.S. Cl. CPC G02B 21/365
USPC 348/79

(57) ABSTRACT

Phase contrast microscopy images are collected of a liquid sample containing one or more microscopic objects. The images are analyzed to track the motion of the microscopic objects within the liquid sample. Using the updated locations of the tracking objects, a controller can generate control signals for controlling the microscopy parameters, to ensure that the portion of the liquid sample which is imaged includes the tracking objects. The tracking objects may be cells or cell-spheres. Thus, the system can, for example, track cells and cell-spheres, to observe their growth, during a long time-lapse experiment.

### FIELD OF THE INVENTION

The present invention relates to a method and system for tracking the motion of microscopic objects, such as cells or cell spheres, within a three-dimensional volume using microscopy images (such as bright field microscopy images or phase contrast microscopy images) captured at successive times. The term “cell sphere” is used to mean a cluster of cells, and is a generalization of the more common terms “neurosphere”, which means a cluster of neurons which developed from a single cell.

### BACKGROUND OF THE INVENTION

It is known to provide an experimental system in which at least part of a three-dimensional liquid sample (i.e. a small volume of liquid) is imaged using a phase contrast microscope. There is a camera for capturing (i.e. recording) microscopy images formed by the microscope. The arrangement includes a microscopic stage for supporting the liquid sample, and which is motorized to allow the liquid sample to be moved relative to the microscope under the control of a user. The phase contrast microscope generates a number of two-dimensional images of respective layers of the liquid sample, at respective distances along the optical axis of the microscope. The set of two-dimensional images is referred to as an image “volume set”.

### SUMMARY OF THE INVENTION

In general terms, the present invention proposes a system for analyzing microscopy images of a liquid sample, so as to track the motion of one or more microscopic objects (“tracking objects”) in suspension within the liquid sample. Typically, the microscopy images are phase contrast microscopy images.

The tracking objects may be cells or cell-spheres. Thus, the system can track the cells and cell spheres, and for example use the corresponding portions of the captured images to measure any changes of the cells or cell spheres (e.g. their growth), during a long time-lapse experiment. A typical duration of the experiment may be more than 24 hours (since the life cycle of certain cells, such as neural stem cells, is 24 hours), and is typically about 3-5 days. In this way, the inventions makes it possible to investigate the cells or cell spheres without requiring the use of bio-markers.

Using the updated locations of the tracking objects, a controller can generate control signals for controlling the microscopy parameters, such as the focusing position of the microscope and/or the relative positions of the microscope and liquid sample, to ensure that the portion of the liquid sample which is imaged includes the tracking objects.

### BRIEF DESCRIPTION OF THE FIGURES

An embodiment of the invention will now be illustrated for the sake of example only with reference to the following drawings, in which:

FIG. 1 shows schematically an embodiment of the present invention;

FIG. 2 shows schematically the sequence of operations performed by the embodiment; and

FIG. 3 shows the flow of information within the embodiment.

### DETAILED DESCRIPTION OF THE EMBODIMENTS

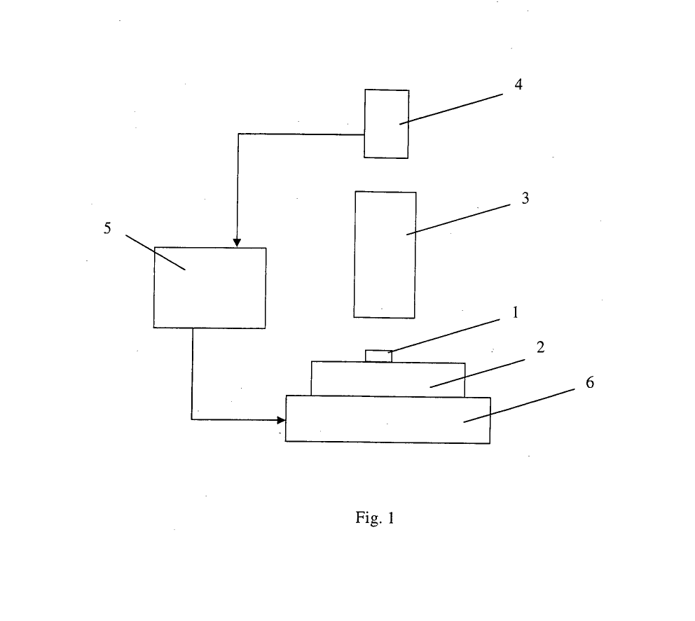

Referring to FIG. 1, a possible embodiment of the invention is shown. A liquid sample is provided within a container 1. The container 1 is positioned on a platform 2 of a microscopic stage. The liquid sample is imaged by a digital phase contrast microscope 3, and images produced by the microscope 3 are captured by a camera 4.

Directions in the plane of the upper surface of the platform 2 are referred to as being in the x-y plane, and the direction perpendicular to the upper surface of the platform 2 (that is, parallel to an optical axis of the microscope 3) are referred to as the z direction.

The microscope 3 is capable of forming images of respective layers in the liquid sample which extend in the x-y directions. The planes are spaced apart in the z-direction.

The images are passed to a computer 5, having a processor and a tangible data storage device storing software. The software includes a controller module which, when executed by the processor, issues first controls signals to control the microscope 3, and second control signals to control a motorized drive system 6 of the microscope stage which moves the platform 2. The control signals sent to the motorized drive system 6 are capable of causing relative motion between the platform 2 and the microscope 3 in two dimensions. That is, the drive system 6 is capable of causing motions of the platform 2 in the x-y directions. The control signals sent to the microscope are capable of altering the range(s) of z-direction positions for which the microscope 3 collects images.

The camera 4 captures images on a time-lapse basis (that is, at a series of successive times, typically spaced apart by equal time intervals). That is, the camera performs time-lapse image acquisition of objects such as cells and/or cell samples suspended within the liquid sample. The times are denoted by an index k. At each time k, the camera 4 captures a plurality of two-dimensional images. Each image is of a different respective x-y plane, and the parallel planes are spaced apart in the z direction. The set of images is referred to as a “volume set”. Thus, there is a respective volume set for each value of k. In fact, as discussed below, the system will track the positions of one or more microscopic objects (“tracking objects”), in a series of cycles denoted by k. At each cycle, if a given tracking object was previously found to have a z-position z, then the microscope will take pictures in a range of z-positions including position z, such as a range with ends z+5 nm and z−5 nm. Similarly, in the case that there is more than one tracking object, the microscope will take images in a respective range of z-positions for each tracking object, centred on the previously found z-position for the corresponding object.

The software of the computer 5 has two modules. Firstly, there is a localizer module for identifying the portion of the images which correspond to the positions of the tracking objects in the liquid sample, thereby tracking the position of the tracking objects in three-dimensions. The localizer outputs information such as location information (data indicating the location of the object(s)) and snapshots (that is, it extracts and optionally exports a portion of the images captured by the camera 4 which show the cells or cell spheres). Secondly, there is the controller module mentioned above, which uses the information provided by the localizer module. The controller automatically controls hardware and/or software of the microscope 3 and the motorized drive system 6. For example, the controller can control the microscope 3 and/or motorized drive system 6 to ensure that certain objects in the liquid sample continue to be in the field (“observing frame”) imaged by the system.

Typically, the system initially receives user input which specifies the one or more tracking objects in the liquid sample. For example, the user may interact with a screen and data input devices (e.g. a keyboard and/or mouse) of the computer 5 to specify manually the tracking objects to be tracked. The initial locations of the tracking objects within the images is thus known. The tracking objects are preferably not provided with bio-markers to aid tracking them. After this, the tracking of the tracking objects may be automatic, that is without human involvement.

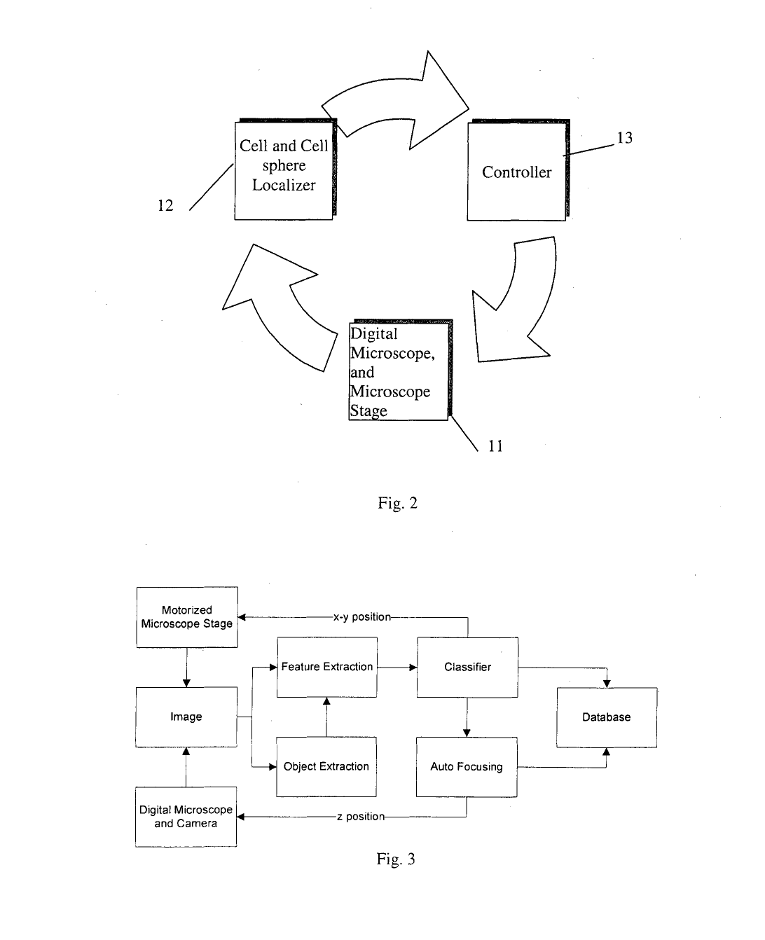

FIG. 2 illustrates the subsequent operation of the device. In a step 11, the digital microscope collects images of at least the part of the liquid sample including the initial positions of the tracking objects. In step 12, the localizer module uses these images to update a record of the location of the tracking objects. At least some of the information generated by the localizer module is stored. In step 13, the controller module generates control instructions for the microscope 3 and/or motorized drive system 6 of the microscope stage, and the system returns to step 11 in which new images are collected in a new cycle of time-lapse image acquisition.

After this loop has been carried out a plurality of times, the information generated by the localizer can be retrieved for the further analysis.

FIG. 3 shows the flow of information within the system of FIG. 1. Together the digital microscope 3 and camera 4 collect images. These are passed to the computer 5, which, in the localizer module (as described in more detail below) performs steps of object extraction, feature localization and classification. Then the controller module generates instructions for the motorized microscope stage 6, and in a auto-focusing step generates instructions for the digital microscrope 3. At least some of the information generated by the localizer module is stored in a database.

We now turn to a detailed explanation of the localizer which analyses an image volume set provided by the microscope 3 and camera 4.

The localizer first identifies all of the objects on each image of the volume set, and registers these objects into an object list (“object extraction”).

Next, the localizer extracts features characterizing these objects (“feature extraction”). These features will subsequently be compared to features of the objects identified in the last cycle of the flow of FIG. 2, or the features specified by the user in the initial step, to determine which of the objects identified in the object extraction step correspond to the tracked objects.

The object extraction and feature extraction steps may be performed on each two-dimensional image separately, or it may be performed only for the z-position corresponding to the last known position of the tracked particle.

Finally, the cell and cell sphere localizer selects the object which has the optimal criteria (it acts as a “classifier”, which identifies one of the objects found in the object extraction step as the tracked object), and exports the related information of this object to be the updated position of the tracked object, to be used for the following operations and the next cycle. Below we present a specific algorithm which can do the classification, but other well-known classifier algorithms can be used. We have also tried using an algorithm which is a suitably modified version of a publicly-known algorithm called MILBoost.

Note that if only one object is identified in the object extraction stage then the feature extraction step and classification step can be omitted.

(a) Object Extraction:

We denote the volume set (i.e. set of x-y images in planes spaced apart in the z direction) for time k by Iₖ. Each two-dimensional image in the volume set is treated separately. Specifically, it is convoluted with a Sobel operator kernel S, where

$$S = [ \begin{matrix}- 1 & - 2 & - 1 \\ 0 & 0 & 0 \\ + 1 & + 2 & + 1\end{matrix} ] * [ \begin{matrix}- 1 & 0 & + 1 \\ - 2 & 0 & + 2 \\ - 1 & 0 & + 1\end{matrix} ] . \qquad ( 1 )$$

The Sobel operator performs a 2-D spatial gradient measurement on an image and so emphasizes regions of high spatial frequency that correspond to edges.

Then, a Gaussian blur operator,

$$G = \frac{1}{2 {πσ}^{2}} {e}^{- \frac{{x}^{2} + {y}^{2}}{2 {σ}^{2}}} , \qquad ( 2 )$$

is applied to each two-dimensional image. This reduces speckle noise in the image. Whereas the operating using the Sobel operator produces the edges of the objects, the blur operator performs a Gabor operation, which merges the edges of the object. Thus, what is emphasized in the images is something generated from the edges of the objects, rather than the objects themselves. We have found that this technique is robust to variations in the shapes and intensities of the objects, and permits the centres of the objects to be tracked.

Finally, a local maximum detection algorithm is performed individually to each two-dimensional image, to find local maxima in the image. The object extraction and feature extraction steps treat each of the local maxima separately. We denote a single one of the local maxima points in a two-dimensional image captured at a time k at a given z position, by \hat{x}ₖ. This point in the two-dimensional image has an intensity i(\hat{x}ₖ, z). It is a local maximum in the sense that

i(\hat{x}ₖ, z)>i(x,z), for all ∥x−\hat{x}ₖ∥₂<c. (3)

Here i(x, z) denotes the intensity at any position x in the x-y plane, and z-position z. The parameter c may be selected by the user, e.g. after viewing the images. The expression ∥ ∥₂ means the two-norm of the vector.

Since the x-y position \hat{x}ₖ is a local maximal point, it is assumed to represent the position of a corresponding tracking object, which may be a cell or a cell sphere, on the corresponding two-dimensional phase contrast image for this value of k and z.

(b) Feature Extraction:

For each of the local maxima \hat{x}ₖ in a given two-dimensional phase contrast image, a set of contours can be obtained based on the distance of the intensities between a local maximal point and the surrounding points. For example, for a given value of a numerical parameter d, a contour can be defined as the set of points x such that

i(x,z)=i(\hat{x}ₖ,z)−d,∀_{Z}. (4)

Here the symbol ∀_{Z} means that 2-dimensional contours are found each of the 2-d images in the volume set.\hat{x}ₖ represents the x-y position of each tracking object, and z is the z-position in the given image volume at time index k. Thus, given two parameters d₁ and d₂, two contours can be used to describe a belt (the region between these two contours) b, which is defined as

b(x|\hat{x}ₖ,z,dₐ,d_{b}), where dₐ≦i(\hat{x}ₖ,z)−i(x,z)≦d_{b},∀_{Z}. (5)

In a given image, the number of belts will be equal to the number of local intensity maxima.

These belts are used as a Haar-like feature extraction on the data space of a wavelet transform. N wavelet transformations are performed successively on the two-dimensional image. These are denoted by the index n=1, . . . N. For the object located at \hat{x}ₖ at time index k, the two parameters dₐ and d_{b} are used to define a “feature” as

$${f}_{{\hat{x}}_{k} , z} ( {d}_{a} , {d}_{b} , w ) = \{ \begin{matrix}w {\sum }_{x ∈ b ( x \vert {\hat{x}}_{k} , z , {d}_{a} , {d}_{b} )}^{ } {W}_{{HH}_{n}} ( x ) , or \\ w {\sum }_{x ∈ b ( x \vert {\hat{x}}_{k} , z , {d}_{a} , {d}_{b} )}^{ } {W}_{{LL}_{n}} ( x )\end{matrix} \qquad ( 6 )$$

for all z, where W_{HH} and W_{LL}, according to a conventional notation represent the HH and LL components in the level n wavelet transform of the given image (that is, different spatial frequency ranges) and w is an weight for the feature. Thus, for each object represented by \hat{x}ₖ, a feature set F_{\hat{x}} can be defined as

F_{\hat{x}}_{ₖ}_{,z}={f_{\hat{x}}_{ₖ}_{,z}⁽¹⁾(dₐ,d_{b},w), f_{\hat{x}}_{ₖ}_{,z}⁽²⁾(dₐ,d_{b},w), . . . f_{\hat{x}}_{ₖ}_{,z}^{(N)}(dₐ,d_{b},w)}, ∀_{z}, (7)

The values of dₐ, d_{b}, w, the selection of the wavelet component (either HH or LL), and the level of the wavelet transform may be randomly predefined at the initial stage. This is because initially we do not know which frequency range contains the critical information. After a few iterations, however, the values which contain critical information will be selected.

(c) Classifier

Using (7), each object \hat{x} on a given two-dimensional phase contrast image can be represented by F_{\hat{x}}_{ₖ}. Thus, for an image volume, which contains the images along z direction, a set of feature sets is defined as

F_{\hat{x}}_{ₖ}={F_{\hat{x}}_{ₖ}_{,1}, F_{\hat{x}}_{ₖ}_{,2}, . . . , F_{\hat{x}}_{ₖ}_{,z}, . . . F_{\hat{x}}_{ₖ}_{,z}} (8)

where F_{\hat{x}}_{ₖ}_{,z} is defined as the feature set of the object z at any given z-position z, and the range of z-positions for which images were collected is denoted by z=1, . . . ,Z (as discussed above, this range is centred on the z-position derived in the previous cycle). For each tracking object, the number of F_{\hat{x}}_{ₖ} is equal to the number of maxima found above using Eqn (3).

For the tracking of an object at position \hat{x}, in each cycle, the feature set Fₓ is obtained for each of the objects identified by the object extraction step using the microscope images of the image set. These feature sets are used as the training patterns of a classifier implemented based on an online machine learning algorithm, which outputs:

$$( {x}_{k + 1} , {z}_{k + 1} ) = {arg max}_{x , z} ℒ ( {I}_{k + 1} , {P}_{{\hat{x}}_{k}} , {N}_{{\hat{x}}_{k}} ) . \qquad ( 9 )$$

where \hat{z} denotes the value of the z-position found in the previous cycle (i.e. cycle k), and

$${\tilde{z}}_{k + 1} = {argmax}_{z} AF ( R ( x , z \vert {\hat{x}}_{k + 1} , {\hat{z}}_{k + 1} , {d}_{c} ) ) . \qquad ( 12 )$$

That is, P_{\hat{x}}_{ₖ} is used to denote the value of F_{\hat{x}}_{ₖ}_{,z} for a certain sub-range composed of 2c+1 z-positions (centred on the z-position found in the last cycle), and N_{\hat{x}}_{ₖ} is used to denote all the other values of F_{\hat{x}}_{ₖ}, both those falling outside the sub-range of z-positions and those relating to other intensity maxima. The character L used in Eqn (9) is a formal term denoting likelihood. Iₖ₊₁ denotes the obtained phase contrast image volume at time index k+1. Thus, the optimal prediction of x-y position, \hat{x}ₖ₊₁, and optimal prediction of z position, \hat{z}ₖ₊₁ are obtained.

We now turn to a discussion of how the embodiment performs the auto-focusing operation of FIG. 3. On a given phase contrast image volume, with an tracking object located at (\hat{x}ₖ,\hat{z}ₖ), a Region of Interest (ROI), R(x,z), is defined. This is done as:

R(x,z|\hat{x}ₖ,\hat{z}ₖ,d_{c}) defined as i(x,\hat{z}ₖ)≧i(\hat{x}ₖ,\hat{z}ₖ)−d_{c}, ∀x,z (11)

where R(x, z|\hat{x}ₖ,\hat{z}ₖ,d_{c}) represents the ROI on a z-position in the given image volume. By using a Auto Focusing (AF) algorithm, an optimal focusing z can be from

$${\tilde{z}}_{k + 1} = {arg max}_{z} AF ( R ( x , z \vert {\hat{x}}_{k + 1} , {\hat{z}}_{k + 1} , {d}_{c} ) ) . \qquad ( 12 )$$

The computer 5 sends a control signal to the microscope 3 to cause it to have this optimal focusing value.

The new position \hat{x}ₖ₊₁, provided in Eqn. (9), and new focusing point, \tilde{z}ₖ₊₁, obtained from Eqn. (12), are used to control the microscope and the stage. That is, the computer 5 sends a control signal to the microscope 3 to cause it to have this optimal focusing value, and to the drive system 6 of microscope stage to ensure that the new position \hat{x}ₖ₊₁ is close to the centre of the viewing field. Then the microscopy is ready to go for the next time the loop of FIG. 2 is performed.

Although only a single embodiment of the invention has been described, many variants of the invention are possible within the scope of the invention as defined by the claims. For example, although the invention may be implemented using a phase contrast microscope images, it may also be applied if the microscope is of the type which generates bright field images.

1. A system for observing one or more objects within a liquid sample, the system comprising:
a microscope for forming images of the liquid sample, the images being of respective layers of the liquid sample, the layers being transverse to an optic axis of the microscope and relatively displaced from each other parallel to the optic axis;
a camera for capturing images formed by the microscope;
a localizer arranged to analyze the captured images, and, using a set of previously stored locations for each of the respective objects, to update the set of locations for the respective objects.

2. A system according to claim 1 further including a controller for generating control signals based on the updated locations, the control signals being for controlling the relative positions of the microscope and a platform for supporting the liquid sample, to vary the portion of the liquid sample which is imaged by the microscope.

3. A system according to claim 2 in which the controller is arranged to identify a region of interest in the liquid sample using the updated locations, and said control signals include signals for controlling the focus of the microscope to capture images of layers of the liquid sample corresponding to said region of interest.

4. A system according to claim 1 in which the localizer includes an object identifier for identifying portions of the captured images corresponding to the objects, a feature extraction unit for extracting features of the identified portions of the images, and a classifier for updating the set of stored locations based on the features.

5. A system according to claim 4 in which the object identifier seeks local intensity maxima in the images.

6. A system according to claim 5 in which, prior to seeking the intensity maxima, the object identifier processes the captured images with a Sobel operator and/or a Gaussian blur.

7. A system according to claim 4 in which the feature extraction unit performs wavelet transformations in regions of the captured images selected based on the identified portions of the images.

8. A system according to claim 7 in which the regions are bands encircling the identified portions of the images, the bands being selected based on contours having equal intensity in the captured images.

9. A system according to claim 7 in which the feature extraction unit generates, for each identified position of the image, a respective data-set encoding the results of the wavelet transformations at multiple wavelet levels.

10. A system according to claim 4 in which the classifier uses an algorithm.

11. A system according to claim 1 in which the microscope is a phase contrast microscope.

12. A method observing one or more objects within a liquid sample, the method comprising:
capturing microscopy images of the liquid sample, the images being of respective layers of the liquid sample, the layers being transverse to an optic axis of the microscope and relatively displaced from each other parallel to the optic axis;
analyzing the captured images, and, using a set of previously stored locations for each of the respective objects, to update the set of locations for the respective objects.

13. A method according to claim 12 further including, based on the updated locations, controlling the relative positions of the microscope and platform, to vary the portion of the liquid sample which is imaged by the microscope.

14. A method according to claim 13 including identifying a region of interest in the liquid sample using the updated locations, and controlling the focus of the microscope to capture images of layers of the liquid sample corresponding to said region of interest.

15. A method according to claim 11 in which said objects are cells or cell spheres, the method further including analyzing regions of the captured images including the updated locations, to study changes in the cells or cell spheres.
